(19) United States
(12) Patent Application Publication
(10) Pub. No.: US 2011/0004338 A1
(43) Pub. Date: Jan. 6, 2011

(54) Vending system and method for small articles

(76) Inventor: James S. Bianco, Suffield, CT (US)

Correspondence Address: ALIX YALE & RISTAS LLP, 750 MAIN STREET, SUITE 1400, HARTFORD, CT, 06103, US

(21) Appl. No.: 12/660,309

(22) Filed: Feb. 24, 2010

Related U.S. Application Data
(60) Provisional application No. 61/208,411, filed on Feb. 24, 2009.

(51) Int. Cl. G06F 17/00; G06K 7/14; G06K 7/01

(52) U.S. Cl. 700/235; 700/232; 235/375; 235/380; 235/462.13

(57) ABSTRACT

A vending system and a method for counting for small articles, such as jewelry items, involves an array of bins for the items. The unique identification is placed on each bin. The identification is scanned with a scanner when a selected article is removed from the bin. The selected article may then be correlated with a price for the selected article.

### CROSS-REFERENCE TO RELATED APPLICATION

This application claims the priority of U.S. Provisional Patent Application No. 61/208,411 filed Feb. 24, 2009, the entirety of which is incorporated herein by reference.

### BACKGROUND

This disclosure relates generally to systems and methods for identifying items and processing information concerning same for commercial applications. More particularly, this disclosure relates to systems and methods for accounting for multiple items of different types.

The article vending system and method herein has particular applicability in connection with accounting problems and tasks which arise in certain specialized jewelry businesses. One such exemplary business involves customer self-selection of various items to be integrated into a piece of jewelry such as, for example, a charm bracelet. The items may be placed in bins of a tray, such as, for example, a 6×10 or a 60 bin tray. The trays may be vertically arranged in racks which are pulled out for accessibility. In one system, there are ten trays and accordingly, there are 600 bins. Each bin contains multiple duplicates of the same jewelry items such as a particular charm or jewelry item. Accordingly, each bin contains unique charms or a charm which is distinct from any charms or other jewelry items of any of the other bins.

The customer selects the item and it is removed from the bin. Typically, each different charm or item has a specific price. Accordingly, to be properly billed for a specific jewelry project, each item must be identified and correlated with a price and a total price determined. While such jewelry vendor stations have proved quite popular, accounting for the selected items and preparing a price list has become quite tedious and labor intensive. Typically, it is not possible because of the relatively small sizes to affix a bar code, ID tag or other identification directly onto the jewelry item. Accordingly, conventional electronic processing has been problematic.

An additional obstacle to efficient electronic accounting is that there is commonly no power in the vicinity of the jewelry racks which are stand alone substations within a jewelry establishment. There is typically no ready accessibility to nearby electrical power or other communications and very little available surface area for a terminal of any kind.

### SUMMARY

Briefly stated, a vending method for processing articles, each type of which is contained in a bin in an array of bins, has a special applicability to small articles. A unique identification is placed on each bin. The identification is scanned with a scanner in correspondence with the selected article removed from the bin. The selected article is identified and correlated with a price for the selected article. The steps are replicated for the various subsequently selected articles.

If an article is returned to the bin, the scanner scans the identification and the returned article is identified and information is processed to correlate a credit for the returned article. The scanner housing is placed in engagement with a side location of the bin and is aligned against an adjacent orthogonal side of the bin. Information describing the articles and corresponding prices is compiled and presented.

A vending system for processing various segregated items is employed for a plurality of trays, each having a unique identification. Each tray has an array of bins with a unique identification. Each bin typically contains a plurality of substantially identical articles. A console has a keyboard and a fixed scanner. A bar code scanner is flexibly connected to the console. A processor communicates with the console so that the bar code scanner scans an identification which corresponds with the removal of an article from the bin. The fixed scanner reads a tray identification and the processor processes the information from the read tray identification and the bar code scanner identification to identify the article removed from the tray.

The processor correlates the article with the price. A printer is employed to print out information concerning the identification of the article the price. The bar code scanner is configured with a first side having an optical scanner communicating through the side and an adjacent orthogonal positioning side. The scanner is dimensioned and the bin identification is located at a pre-established position of the bin so that the scanner may be positioned against a corner location of the bin for proper alignment with the bar code. The console may also include a card reader. Information compiled in the processor may be remotely communicated over the internet or a network. The console has a key input which corresponds to the return of an article to the bin, and the processor generates credit information upon reading the bin identification to produce a credit for the returned article.

### BRIEF DESCRIPTION OF THE DRAWINGS

FIG. 1 is a schematic block diagram of the article vending system;

FIG. 2 is a photo of a terminal portion of the article vending system and an associated tray as employed in a preferred application;

FIG. 3 is a photo illustrating how the article vending system may be employed for the application of FIG. 2;

FIG. 4 is an electrical schematic diagram of a processor module and associated components for the article vending system of FIG. 1;

FIG. 5 is a perspective view of a terminal module and a scanner employed in the article vending system of FIG. 1;

FIG. 6 is a rear perspective view of the terminal module of FIG. 5;

FIG. 7 is a perspective view of a printer that may be employed for the article vending system of FIG. 1;

FIG. 8 is a perspective view of a processor module for the article vending system of FIG. 1;

FIGS. 9A, 9B and 9C are respectively front elevational, left side and right side views of the scanner for the article vending system of FIG. 1; and

FIG. 10 is a chart of bar codes employed with the article vending system of FIG. 1.

### DETAILED DESCRIPTION OF THE PREFERRED EMBODIMENTS

With reference to the drawings wherein like numerals represent like parts throughout the several Figures, vending system particular applicable for small articles is generally designated by the numeral 10. The system employs a terminal module 12 with a bar code scanner 14. The terminal module communicates with a processor module 16 which controls a printer 17 and a cash drawer 18. The processor module 16 may connect with a battery module 20 or a power injection module 22. Power may also be supplied by an A/C power module 21. Data for the processor module may be input from a USB memory stick 29. Remote communication may be via a direct connection to a WI-FI router 24 to a WI-FI port 26 or a direct connector 28 with the internet or to a network.

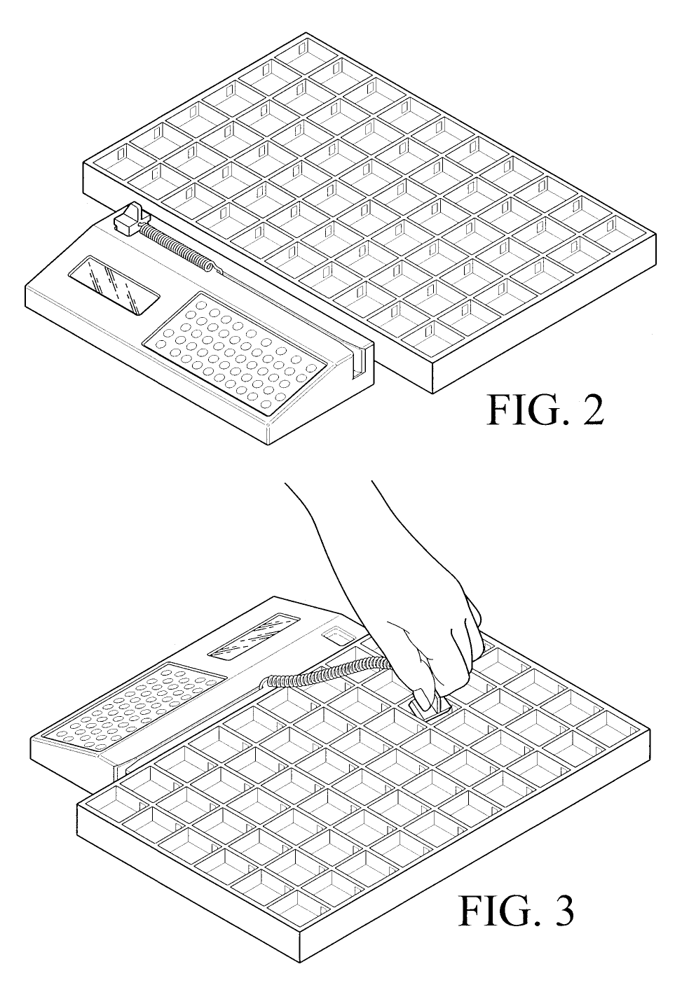

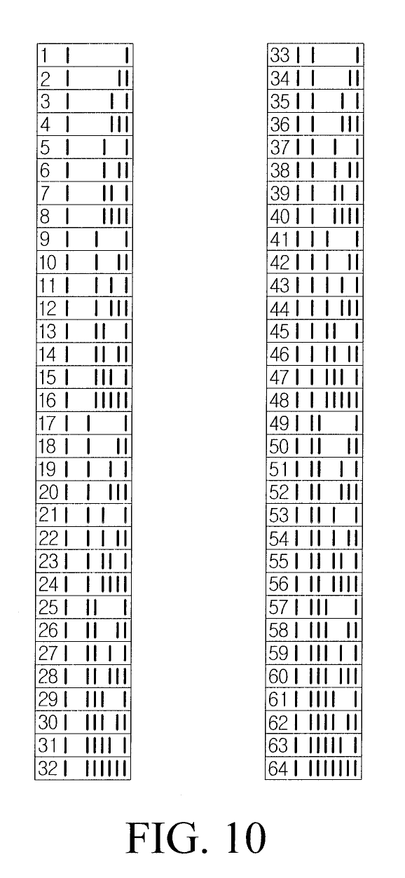

The article vending system 10 operates in conjunction with a tray 30 having a rectangular grid of bins 32. With reference to FIGS. 2 and 3, in a typical vendor context, each of the bins 32 has multiple identical jewelry items which differ from that of the other bins. Each of the bins is preferably identical in shape and dimensions and is affixed with a unique bar code 34 at a side rear corner location thereof at a uniform pre-established position. The bar codes are designated generally by the numeral 34 but it should be understood that each bin of a given tray has a unique bar code. The bar, codes 34 in one preferred embodiment are positioned at precisely the same corresponding location of a bin 32. Exemplary codes are set forth in FIG. 10. The unique bar codes are employed to uniquely identify each bin, and accordingly, can be associated with an identification which corresponds to each of the jewelry items placed in the bin.

Each drawer also has a bar code 36 which is placed at a central front and/or rear portion thereof for identifying each unique tray. The tray and bin identifications can be correlated with a description, price and other corresponding data and information. It will be appreciated that there may be multiple trays as illustrated in FIGS. 2 and 3, for example, ten trays 30 for a given system, although the specific number of trays and/or bins can vary over wide ranges and are not a limitation of the applicability of the product identification system. In one preferred method, the terminal console is properly positioned or centered on a selected tray so that the bar code for the tray is read through a fixed scanner 38 of the terminal console.

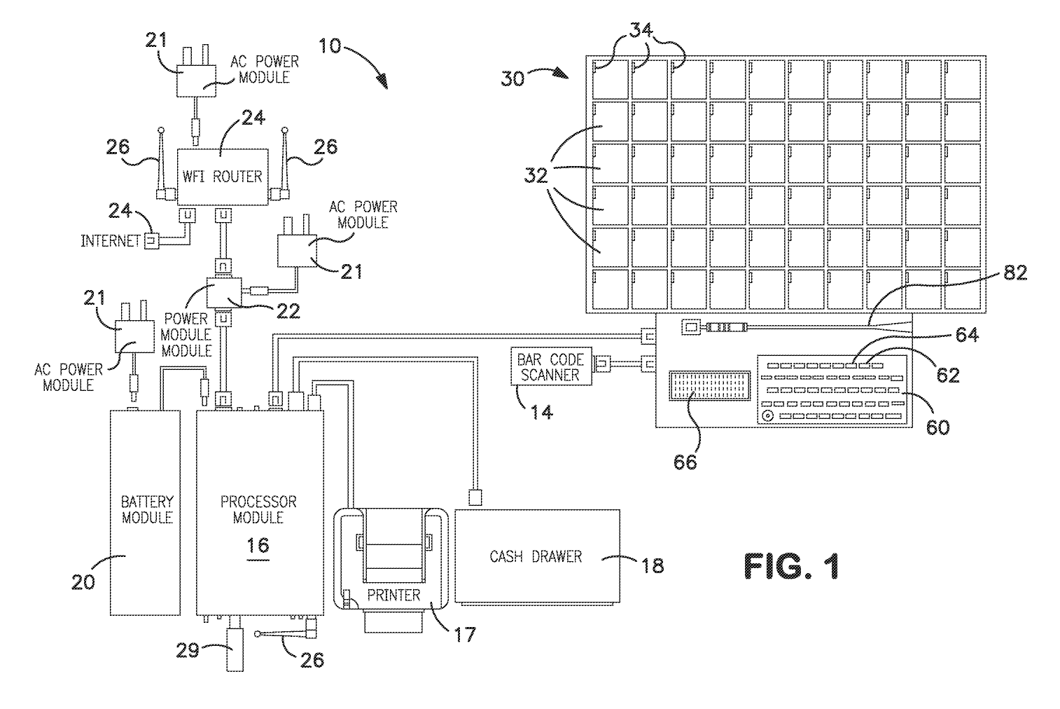

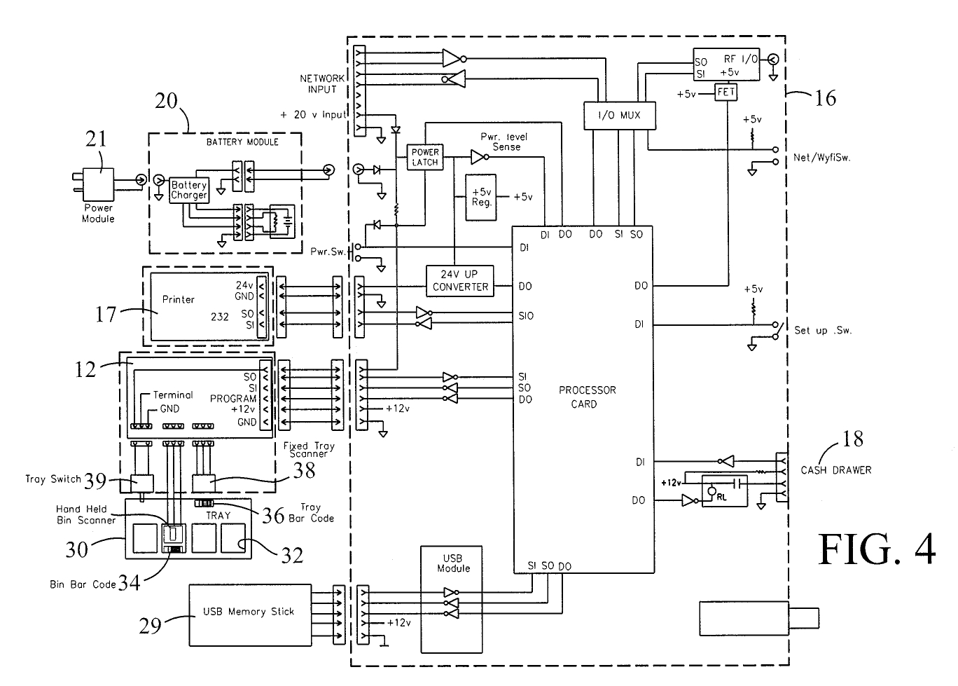

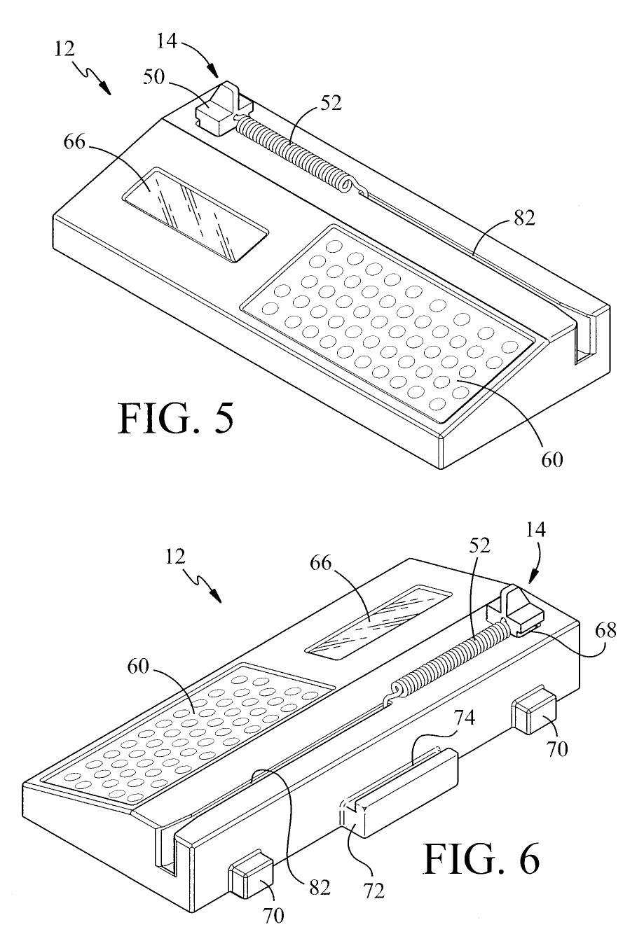

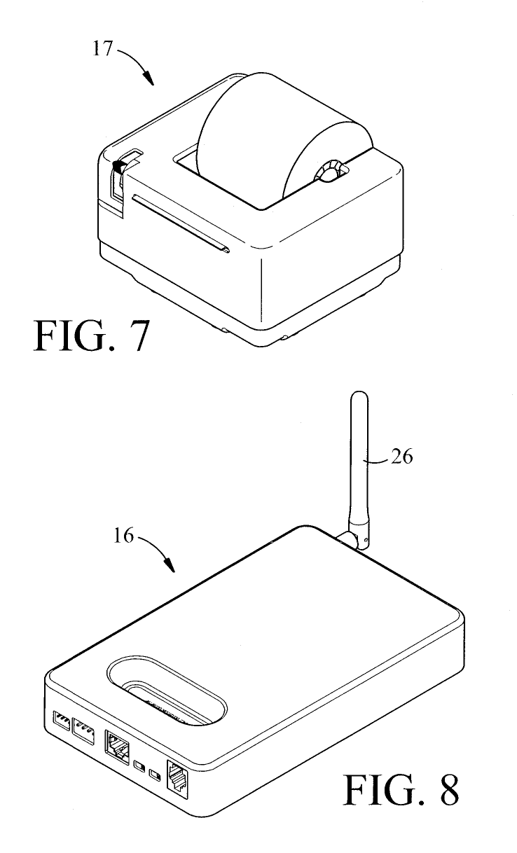

With reference to FIGS. 1, 5 and 6, the terminal module 12 is a compact console which is positionable on a counter top and includes a keyboard 60 with alphanumeric and function keys, including a select key 62 and a return key 64. Various information produced by the identification system may be shown on a video display 66. The terminal module has a well 68 (FIG. 6) for retaining the scanner 14. The rear of the terminal module includes a pair of integral supports 70 and a central retaining support 72 which has an upper flange 74. The front of a tray rests on the supports 70, 72 and the flange 74 engages and retains the underside back of the front panel of the tray. Preferably, the tray is engaged in a slightly angled relationship as best illustrated in FIGS. 2 and 3. The module may include, at its rear, a fixed scanner 38 (FIG. 4) for reading the unique bar code 36 for the tray. Alternatively, the scanner 14 for the bins may be used to scan the tray bar code 36. In another form, the terminal module includes a pressure sensor 39 (FIG. 4) for detecting the position of the tray which automatically activates the fixed scanner 38 or triggers a message to read the tray bar code 36 before scanning the individual bins.

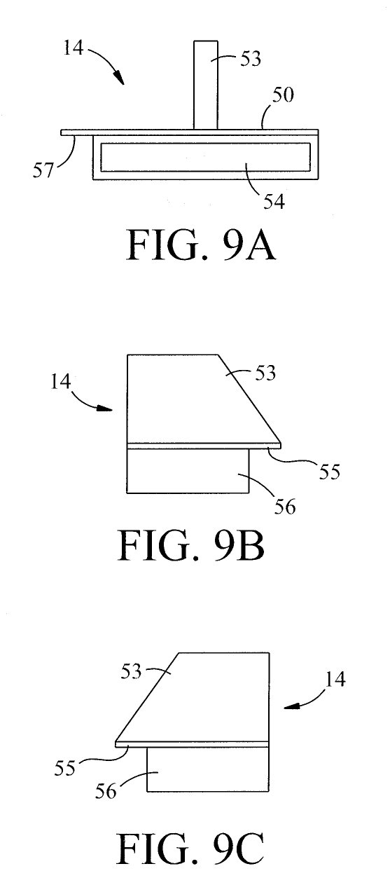

With additional reference to FIGS. 9A, 9B and 9C, the bar code scanner 14 has a specially configured reader or probe housing 50 which is tethered to the end of a flexible cable 52. A medial finger grip 53 projects from the housing top. The bar code scanner probe housing 50 has an optical window 54 at one side and an adjacent orthogonal positioning side 56. The intersecting sides are positioned so that when the housing 50 is pushed into a corner against the sides, the scanner window 54 aligns with the bin bar code 34. A locating flange 55 and 57 at the top of the sides rests on the tops of bin partitions to properly provide a depth position as well as a centering position for aligning the window 54 with the bar code 34. The scanner 14 is thus self-positionable so that the bar code 34 may be efficiently read in any given selected bin since the bar codes 34 are placed in substantially the same position for each of the bins 30. Some embodiments do not require a probe housing configured as previously described, but may scan within a pre-established proximity to the code.

With reference to FIG. 10, a representative bar code scheme which may be employed for the identification of the bins for a given tray is shown. The coding is unique in that a lead digit and a trailing digit are provided to ensure the proper framing of the bar code by the scanner. After the lead start code, there will be a zero digit. These two outputs will essentially define the one and zero analog position levels for the scanner, which analog output is immediately converted to a digital form. The start and end digits, which are always present, will assure proper bracketing for the bar code 32 by the scanner 14. In some preferred embodiments, the scanner probe housing 50 is engaged against and directly positioned in the corner of a bin 30 for identifying the bin. For other embodiments, the scanner only needs to be positioned in a sufficiently close proximity to the bar code to accomplish the proper input scan.

When a jewelry item is desired to be removed from a bin, the scanner 14 is positioned to scan the bar code 32 for the selected bin 30 as shown in FIG. 3. An appropriate keyboard stroke on the select key 62 registers the corresponding item removed. The identifier signal is transmitted and processed via the processor module 16 to correlate the bin (and tray) identification and the price for the item and display same on the screen or display 66 of the terminal module. The output may also be sent to a printer 17 which serially records the various items to be purchased. The process is serially repeated as the customer selects from various bins and, upon each selection, scans the appropriate identification code which is then entered into the system. The process, naturally, may also be continued for each of the various subsequently selected trays.

The processor 16 may also generate a signal for activating the cash drawer 18. If it is desired to return an item to a bin, the return key 64 is then depressed, and the scanner 14 is placed against the appropriate bar code 34 for scanning same. Accordingly, it will be appreciated that the foregoing system provides a means for monitoring the inventory of the items once an initial inventory of the items is established.

The terminal module 12 also has a card slot 82 for a magnetic reader. A card (not illustrated) may be inserted into the slot and the customer name correlated with the purchase for purposes of charging the purchase or merely for purposes of an output statement. In addition, the magnetic reader may be employed for pre-encoding to generate information and a number for establishing a customer account. It will be appreciated that once all of the jewelry items have been selected, an itemized list with the price and the total balance due can then be easily generated on the printer 17 as well as within the processor module. If a debit or credit card has been used, the appropriate accounts can also be properly debited automatically.

It will be appreciated that the generated information may be transferred over the internet or via WI-FI or may otherwise be retained within the system or recorded on various media. The processor module 16, printer 17 and cash drawer 18 may be housed or placed on shelves in a sales counter and easily accessed for usage by sales personnel.

While preferred embodiments have been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed:

1. A vending method for processing articles, each type of which is contained in a bin of an array of bins comprising:
(a) placing a unique identification on each bin;
(b) scanning said corresponding identification with a scanner in correspondence with removal of selected articles from a bin;
(c) identifying said selected article;
(d) processing information to correlate a price for said selected article; and
(e) repeating steps (b)-(d).

2. The method of claim 1 further comprising:
(f) returning an article to a bin;
(g) scanning said corresponding identification with a scanner;
(h) identifying said returned article; and
(i) processing information to correlate a credit for said returned article.

3. The method of claim 1 wherein step (b) further comprises placing a housing of said scanner in engagement with a side location of said bin and aligning said scanner against an adjacent orthogonal side of said bin.

4. The method of claim 1 further comprising printing information describing said article and its corresponding price.

5. The method of claim 1 further comprising compiling information concerning prices and the identified articles and generating a visually observable output thereof.

6. A vending system for processing various segregated articles comprising:
a plurality of trays, each having a unique identification, each tray having an array of bins with a unique bin identification wherein each bin contains a plurality of substantially identical articles;
a console having a keyboard and a fixed scanner;
a bar code scanner flexibly connected to said console and in communication therewith; and
a processor in communication with said console so that the bar code scanner scans a bin identification in correspondence with the removal of an article from said bin, said fixed scanner reads a tray identification, and said processor processes the information from the read tray identification and the bar code scanner identification to identify the article removed from said tray.

7. The system of claim 6 wherein said processor correlates the identified article with a price.

8. The system of claim 6 further comprising a printer in communication with the processor to print out information concerning the identification of the article.

9. The system of claim 6 wherein said bar code scanner comprises a probe having a first side with an optical scanner communicating through said side, and an adjacent orthogonal positioning edge.

10. A system of claim 6 wherein said bin identification is located at a pre-established position of the bin and said bar code scanner is positioned against a corner location of a bin for proper alignment with said bar code.

11. The system of claim 6 wherein said console includes a card reader.

12. The system of claim 6 wherein said processor compiles information which is remotely communicated over the internet or a network.

13. The system of claim 6 wherein said console has a key input which corresponds to a return of an item to the bin, and the processor generates credit information upon reading the bin identification to provide a credit for a returned article.

14. A vending system for processing various segregated articles comprising:
a plurality of trays, each having a unique identification, each tray having an array of bins with a unique bin identification wherein each bin contains a plurality of substantially identical articles;
a processor;
a first scanner in communicating with said processor; and
a bar code scanner in communication with said processor, so that the bar code scanner scans a bin identification in correspondence with the removal of an article from said bin, said first scanner reads a tray identification, and said processor processes the information from the read tray identification and the bar code scanner identification to identify the article removed from said tray.

15. The system of claim 14 wherein said processor correlates the identified article with a price.

16. The system of claim 14 further comprising a printer in communication with the processor to print out information concerning the identification of the article.

17. The system of claim 14 wherein said bar code scanner comprises a probe having a first side with an optical scanner communicating through said side, and an adjacent orthogonal positioning edge.

18. A system of claim 14 wherein said bin identification is located at a pre-established position of the bin and said bar code scanner is positioned against a corner location of a bin for proper alignment with said bar code.

19. The system of claim 14 and further comprising a console wherein said console includes a card reader in communication with said processor.

20. The system of claim 14 wherein said processor compiles information which is remotely communicated over the internet or a network.
